(19) United States
(12) Patent Application Publication
(10) Pub. No.: US 2025/0361710 A1
(43) Pub. Date: Nov. 27, 2025

(54) LID AND LID SYSTEM

(71) Applicant: Jets AS, Hareid (NO)

(72) Inventor: Erlend Leonard KVALSUND, Vigra (NO)

(21) Appl. No.: 18/873,811

(22) PCT Filed: Jun. 13, 2023
(86) PCT No.: PCT/NO2023/050138

§ 371 Date: Dec. 11, 2024

(30) Foreign Application Priority Data
Jun. 13, 2022 (NO) 20220667

(51) Int. Cl. E03F 1/00

(52) U.S. Cl. CPC E03F 1/006; E03F 2201/00

(57) ABSTRACT

A lid (3) adapted for fluid tight sealing engagement with an opening (2) in a closed system where a pressure on an outside of the closed system is higher than a pressure on an inside of the closed system, wherein the lid is arranged to perform a pivoting movement around a pivot axis for opening the lid.

### INTRODUCTION

The present invention concerns a pivotable lid. The lid may be used as a fluid tight sealing of an opening in a closed system. The invention also provides a lid system for fluid tight sealing of an opening in a vacuum system. The closed system may be a vacuum system. The vacuum system may e.g. be a vacuum sewage system for toilets, sinks, or organic waste from fish farming etc. The vacuum system may have many different uses as e.g. in transporting condensed water e.g. in refrigerators and coolers in super markets, or the vacuum system may be a vacuum tank. Further uses of the invention are also disclosed.

### BACKGROUND

Vacuum systems, or other closed systems where the pressure on the outside is higher than the pressure on the inside of the closed system, must be inspected from time to time for clean out, removal of objects, or for repair and maintenance of the vacuum system. The vacuum system may therefore be provided with openings covered by e.g. pipe fittings or pipe fitting assemblies or lids that may be removed to get access to the inside of the vacuum system. The prior art solutions for vacuum system fittings or lids uses screws or bolts or other devices for attaching the vacuum pipe/system fitting or lid securely to the vacuum pipe. The prior art solutions often require tools for removal and attachment of the lid to the vacuum system. Opening the lid or pipe/system fitting in the prior art solutions also require that the pressure in the vacuum system is equalized with the surroundings before being able to open the lid or pipe fitting.

### SUMMARY OF THE INVENTION

The present invention provides a solution to or at least alleviates the problems discussed above.

The invention provides a lid adapted for fluid tight sealing engagement with an opening in a closed system. A pressure on an outside of the closed system may be higher than a pressure on an inside of the closed system. The lid is arranged to perform a pivoting movement around a pivot axis for opening the lid.

The lid may be fluid tight held in place in the opening by balancing the forces on the lid due to a pressure difference between the inside and the outside of the closed system. The pivot axis may be arranged in a middle part of the lid. The pivot axis may divide an area of the lid in a first area and a second area, and wherein the first area is equal to or about equal to the area of the second area. The pivot axis may be provided by a longitudinal element, a geometry in the lid or a geometry in the opening. The closed system may be a vacuum system. The opening in the system may be an opening in a pipe or a tank. The pivoting movement for opening the lid may be initiated by a force applied on a part of the lid in an area near or on a periphery of the lid away from the pivot axis. The lid may be provided with a fluid tight sealing element around the periphery of the lid for sealing engagement between the opening in the closed system and the lid. The periphery of the lid may be arranged to be able to slide on a surface of the opening for at least a part of the pivoting movement.

The invention also provides a lid system for fluid tight sealing of an opening in a closed system where a pressure on an outside of the closed system is larger than a pressure on an inside of the closed system, the lid system comprising a housing element provided with the opening, wherein the housing element further comprising at least one connecting element for connecting the housing element to the closed system; and a lid arranged to perform a pivoting movement around a pivot axis for opening the lid.

The lid may be fluid tight held in place in the opening by balancing the forces on the lid due to a pressure difference between the inside and the outside of the closed system. The pivot axis may be arranged in a middle part of the lid. The pivot axis may divide an area of the lid in a first area and a second area, and wherein the first area is equal to or about equal to the area of the second area. The pivot axis may be provided by a longitudinal element, a geometry in the lid or a geometry in the opening. The opening in the housing may be provided with two opposing pivot areas defining the pivot axis. The opening may be provided with a fluid tight sealing element for sealing engagement between the opening and the lid. The lid may be provided with a fluid tight sealing element around a periphery of the lid for sealing engagement between the opening and the lid. The outer periphery of the lid may be arranged to be able to slide on a surface of the opening for at least a part of the pivoting movement.

The pivoting movement for opening the lid may be initiated by applying a force on a part of the lid in an area near or on a periphery of the lid away from the pivot axis. The closed system may be a vacuum system.

A lid adapted for fluid tight sealing engagement with an opening in a closed system wherein the lid is arranged to perform a rotating movement around a pivot axis for opening the lid.

A housing element for a lid system for fluid tight sealing of an opening in a closed system where a pressure on an outside of the closed system is larger than a pressure on an inside of the closed system is also provided. The lid is arranged to perform a pivoting movement around a pivot axis for opening the lid. The housing element has an opening. The housing element may further include at least one connecting element for connecting the housing element to the closed system.

The opening in the housing may extend up from the closed system. A perimeter of the opening may increase in a direction away from the closed system.

The lid or lid system or housing element may be used as an inspection opening in a vacuum sewage system for at least one of toilets, sinks, greywater, black water, water or organic material e.g. in fish farming. The lid or lid system or housing element may be used as an inspection opening in a vacuum system for condensed water, in a vacuum system for transporting condensed water from at least one cooler or refrigerator, in a vacuum system for transport of condensed water from at least one of a cold counter, display fridge or refrigerator counter in a shop or supermarket.

The invention also provides a pivotable lid for fluid tight covering of an opening in a vacuum sewage system. The vacuum sewage system is provided with an opening to be fluid tight closed by the lid. The pivotable lid may be provided with a fluid tight seal for sealing engagement between the opening and the lid. The fluid tight seal may be partly resting in a recess around the periphery of the lid.

The pivotable lid may be arranged to interact with the inside of the opening into the vacuum sewage system through a pivoting movement. A pivot axis for the lid may be provided in the opening by surface areas on which the lid may rest in a closed position where the lid is in sealing engagement with the inside of the opening to provide a fluid tight seal for the vacuum system. The surface areas function as a pivot axis for the lid when opening the lid. This enables the lid to be opened with little force, even though the pressure on the outside of the vacuum sewage system is higher than that on the inside of the vacuum sewage system.

The lid and lid system provides a simple solution that is easy to use, does not require any tools for opening, and may be opened and/or removed even with vacuum present in the vacuum system. All that it takes for opening of the lid is to press gently down at a location on the lid. The location may be marked.

The lid and lid system may also be designed to be opened by a mechanical, electrical or electro-mechanical device providing a force to the lid at a specific location of the lid or lid system. The mechanical, electrical or electro-mechanical device may be operated automatically or semi-automatically. The lid and lid system may be implemented in a number of locations in a vacuum system.

### BRIEF DESCRIPTION OF DRAWINGS

Example embodiments is described with reference to the following drawings. The example embodiments are non-limiting for the invention and further embodiments may be envisaged.

FIGS. 1A-1C illustrates an example embodiment of a sequence of opening and removal of a lid in a lid system with a housing element for a vacuum pipe;

FIG. 1A illustrates the lid in a closed and fluid-tight position covering the opening of a housing element of the vacuum pipe;

FIG. 1B illustrates the vacuum pipe with the lid system from FIG. 1A with the lid in a partly open position after a part of the lid has been depressed and the vacuum pressure overcome for opening of the lid;

FIG. 1C illustrates the housing element of the vacuum pipe with the lid removed from the opening in the housing element;

FIGS. 2A-2C illustrates the example embodiment from FIGS. 1A-1C in longitudinal cross-sectional view of the housing element in the vacuum pipe with lid and the sequence of opening the lid;

FIG. 2A illustrates in a longitudinal cross-sectional view the lid in a closed and fluid-tight position covering the opening in the housing element of the vacuum pipe from FIG. 1A;

FIG. 2B illustrates in a longitudinal cross-sectional view the housing element of the vacuum pipe with opening and lid partly opened from FIG. 1B;

FIG. 2C illustrates in a longitudinal cross-sectional view the housing element of the vacuum pipe with the lid removed from the opening from FIG. 1C;

FIGS. 3A-3C illustrate in a longitudinal partly cross-sectional view the sequence of the opening of the lid from FIGS. 1A-1C but also illustrating an interaction between the lid and an inside of the opening in the housing element.

FIG. 4 is a view of the opening and the housing element of the example embodiment of FIGS. 1-3 seen from partly above.

FIG. 5A illustrates forces acting on the lid of the example embodiment of FIGS. 1-4, when the lid is in a closed position in the opening of the housing element of the vacuum pipe.

FIG. 5B illustrates the lid from FIG. 5A in an open pivoted position.

FIGS. 6A-B illustrate in a side view a lid for a closed system.

FIGS. 6C-E illustrate the lid from FIGS. 6A-B seen from partly above.

### DETAILED DESCRIPTION

Example embodiments will be described with reference to the drawings. These are only examples and further embodiments of the invention may be envisaged. The same reference numerals are used for the same or similar features in all the drawings and throughout the description.

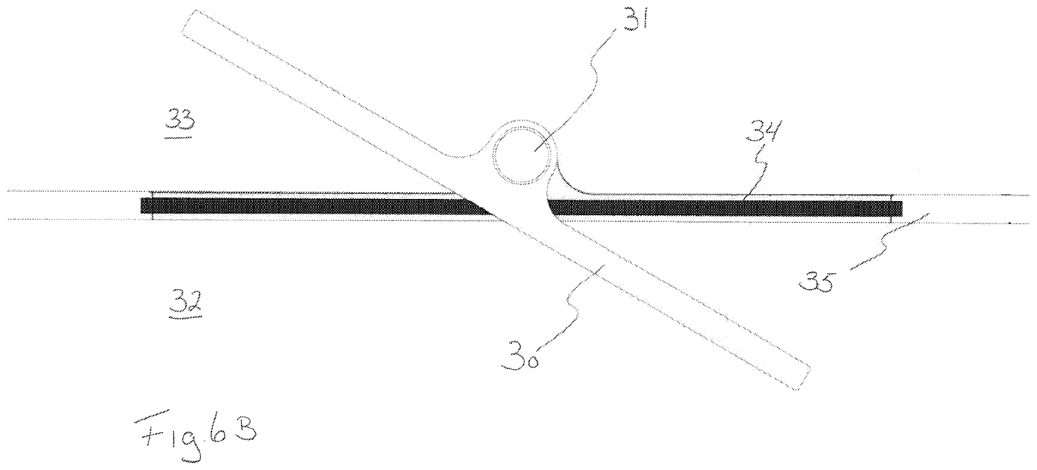

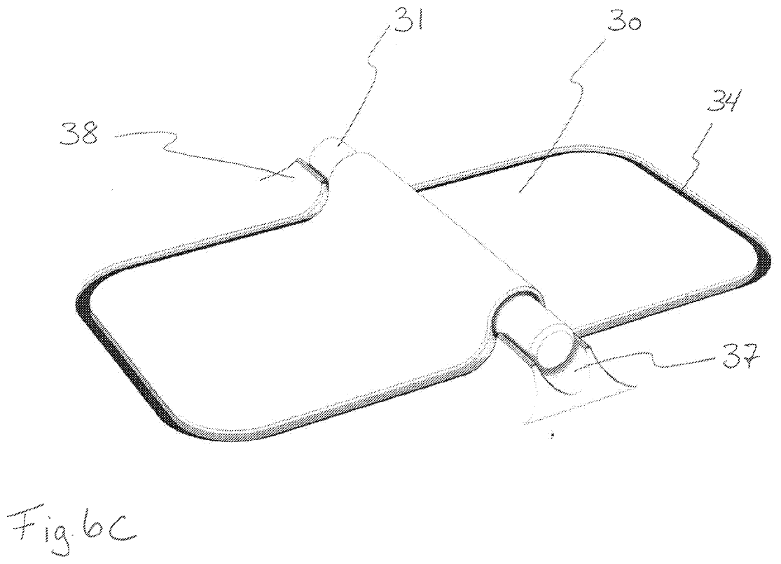

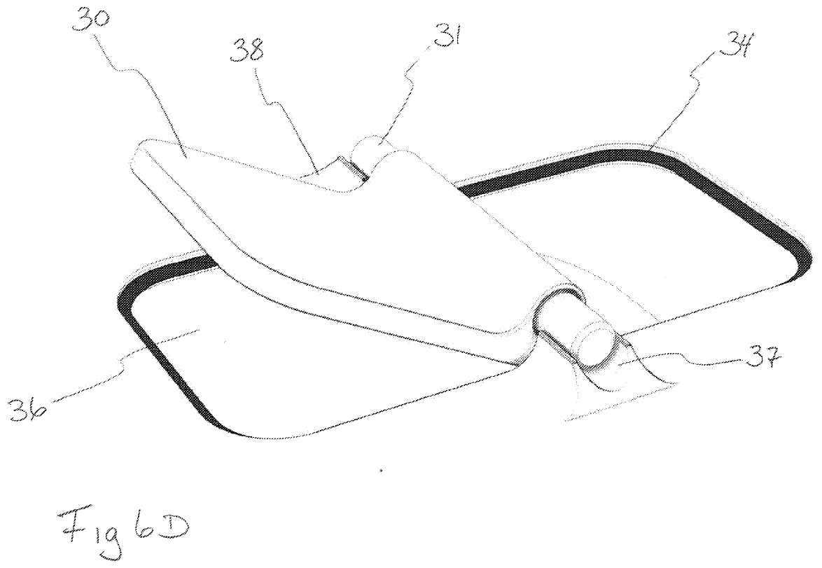

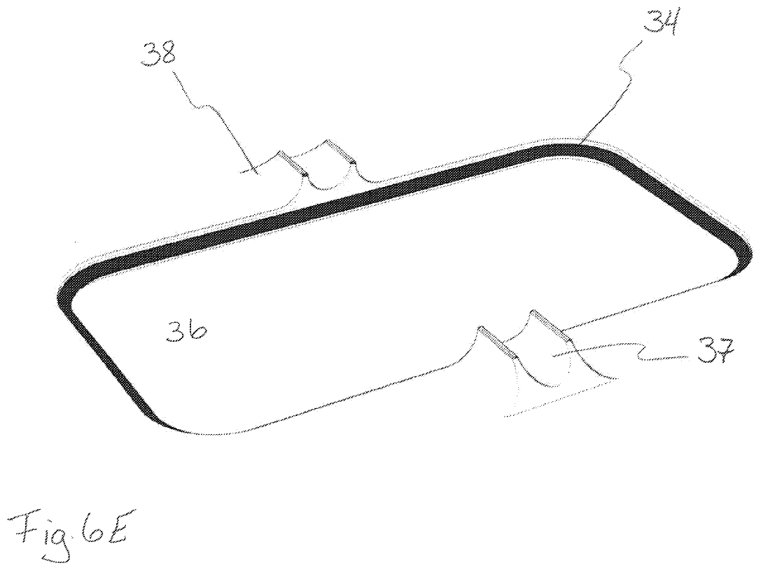

A lid 30 for a closed system is illustrated in FIGS. 6A-6E. In FIGS. 6A-B, the lid 30 is illustrated in a cross-sectional side view. The lid is adapted for fluid tight sealing engagement with an opening in the closed system. A periphery of the lid has a corresponding shape and size as an inside of the opening. The closed system is a system where a pressure on an outside 33 of the closed system is higher than a pressure on an inside 32 of the closed system. The closed system may e.g. be a pipe or a tank. The closed system may be a vacuum system. As the volume inside the closed system has a lower pressure than the pressure on the outside of the lid, the lid experiences a net force sucking the lid into the closed system. The lid is prevented from being sucked into the closed system by an element 31. The element 31 in FIG. 6A is a longitudinal element. The element 31 provides a pivot axis around which the lid may pivot. In a situation where the lid 30 is in place in the opening for sealing engagement with the opening, the net forces acting on the lid is balanced so as to keep the lid in place in the opening providing a fluid tight seal for the opening in the closed system. The lid 30 is arranged to perform a pivoting movement around the pivot axis 31 for opening the lid as illustrated in FIG. 6B. The element 31 around which the lid may rotate may e.g. be a longitudinal element 31 as illustrated in FIG. 6A, a geometry in the lid itself or a geometry in the opening or a geometry in an adjacent structure providing the effect of enabling the lid to perform a pivot movement around the pivot axis 31. The lid 30 is rotated by applying a torque to rotate the lid around the pivot axis 31. The lid 30 may be rotated around the pivot axis 31 by applying a force on the lid sufficiently far removed from the pivot axis and where the applied force is small compared to the forces on the lid caused by the pressure difference between the inside 32 and the outside 33 of the closed system. The small force may be applied on a part of the lid in an area near or on a periphery of the lid away from the pivot axis. The small force should be large enough to overcome the friction in the system. Applying the small force result in a small rotation of the lid around the pivot axis creating a small opening between the periphery of the lid and the opening. This small opening results in equalization of the pressure between the inside 32 of the closed system and the outside 33 of the closed system. When the pressure between the inside 32 and the outside 33 is equalized, the net sum of the forces provided by the pressure difference will be zero and the lid will no longer be held in place in the opening. The lid 30 may then be rotated further as illustrated in FIG. 6B to provide a larger opening or the lid may be removed. The lid is opened from the outside of the vacuum system; i.e. opened on the side of the vacuum system with the highest pressure. The lid solution may be used in systems with a pressure difference where the pressure on the inside of the system is smaller than the pressure on the outside of the system. The closed system may be a vacuum system. The forces on the lid will be explained in detail later with reference to the example embodiment in FIGS. 5A and 5B.

The lid 30 in FIG. 6A is in a position closing an opening of a closed system 35. To provide fluid tight sealing of the opening a sealing element 34 is provided between the periphery of the lid and the opening. The fluid tight sealing element 34 may be arranged in the opening attached to the opening which is clearly illustrated in FIG. 6B where the lid 30 is in a pivoted position. The fluid tight sealing element 34 may alternatively be provided around the periphery of the lid for sealing engagement between the opening in the closed system and the lid. The sealing element may be a separate part of the lid. The sealing element may be an integrated part of the lid.

FIGS. 6C-6E illustrate the lid 30 from FIG. 6A-B seen partly from a side and from above. The lid 30 is provided with a longitudinal element in the form of an axle, shaft or rod. The opening 36 in the housing is provided with two opposing pivot areas 37, 38 defining the pivot axis as illustrated in FIG. 6E where the lid is removed. The longitudinal element is arranged in receiving areas 37, 38 provided on each side of the opening in the closed system. The receiving areas 37, 38 are U-shaped to be able to receive the longitudinal element 31 and maintain the longitudinal element 30 in position along the pivot axis defined by the receiving areas 37, 38 and the longitudinal element 30. The longitudinal element 30 is able to rotate around the pivot axis while arranged in the receiving areas. The pivot axis 31 is arranged in a middle part of the lid 30. The pivot axis 31 divides an area of the lid 30 in a first area and a second area, and wherein the first area is equal to or about equal to the area of the second area. As explained above, the lid 30 is fluid tight held in place in the opening by balancing the forces on the lid due to the pressure difference between the inside and the outside of the closed system. As the first area is equal to or about equal to the second area of the lid, the forces acting on the first area and the second area are equal or about equal which results in a net zero force on the lid. The sealing element between the periphery of the lid and the opening creates friction keeping the lid 30 in the fluid tight engagement position in the opening.

The closed system in FIG. 6 may be a vacuum system. The vacuum system may be any kind of vacuum system e.g. a vacuum tank, a vacuum sewage system for toilets, sinks etc., a vacuum system for use in transport of organic waste in fish farming, a vacuum system for use in transporting condensed water e.g. in refrigerated counters and cold counters in super markets. In the vacuum system illustrated in FIGS. 5A, B the pressure on the inside of the system is 0.45 bar absolute pressure and the outside pressure is atmospheric pressure of 1.0 bar absolute. Other vacuum systems may have a different pressure than atmospheric pressure at 1.0 bar on the outside and a different pressure on the inside. In the vacuum sewage system in FIG. 5A, B, the vacuum pressure may be around 0.4 to 0.6 bar absolute pressure. Other vacuum sewage systems may run with vacuum pressure between e.g. 0.25 to 0.45 bar absolute pressure.

In a vacuum system, the system may detect the vacuum of the system. If the vacuum pump stops, the vacuum in the system decreases. In case of the vacuum decreasing or even disappearing, the lid should be fluid tight also in these situations to prevent undesirable leakage from the vacuum system. Vacuum systems are e.g. used in toilet systems and any leakage is unhygienic. To ensure the lid is tightly held in place in the opening of the housing in case of loss of vacuum in the system, a locking member may be arranged on the lid securing the lid to the opening in the housing. The locking member may be held in place by spring forces. The locking member should be easy to open and close to enable simple removal of the lid from the housing. The locking member may be a snap-on and snap-off solution. The locking member may be designed to be opened and closed by hand of a human. The locking member may also be designed to be open and closed by use of a mechanical, electrical or electro-mechanical device.

The closing mechanism with the lid, the pivot axis and the corresponding shape of the lid and the opening, provides a lid for an opening in a closed system, that can be opened with little force, even though the pressure on the outside of the lid is higher than that on the inside. The opening force of the lid provided by the small additional force may be provided by a gentle push downwards by the hand of a person. The removal of the lid does not require any tools. The lid is also reliably held in place by the vacuum pressure of the pipe as explained above. The lid may thus be pressed in place by use of the hand by a human and the lid is then secured in place by the vacuum in the vacuum pipe. No screws or bolts are required for securely attaching the lid to the vacuum pipe. The lid may be opened without removing the vacuum in the vacuum pipe system. The solution is simple and cost efficient and easy to use. The area to be pushed by the hand of the user may be marked on the lid. The pushing area may be provided on one of the sides of the lid at or near the periphery of the lid sufficiently far removed from the pivot axis of the lid. The pushing area may be at or near the periphery of the lid at or near a line perpendicular to the pivot axis. The area to be pushed may be marked on the lid for easy removal by the user. Operation of the lid may also be performed by a machine. The machine may be manually operated, semi-automatic or automatically operated.

A non-limiting example embodiment of a lid system for a vacuum system is disclosed.

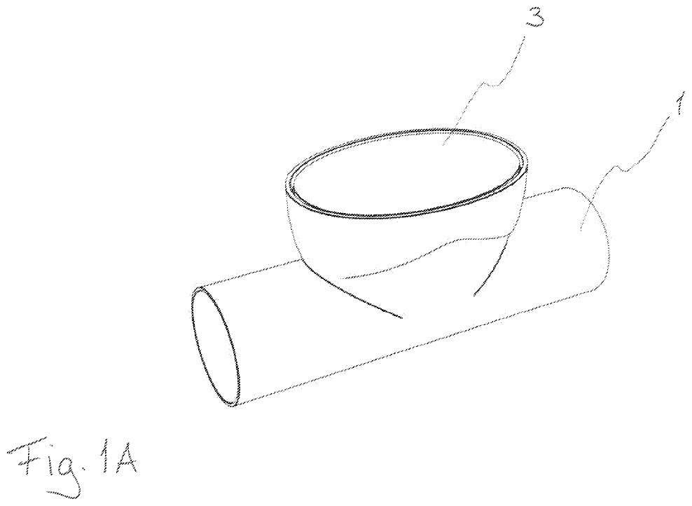

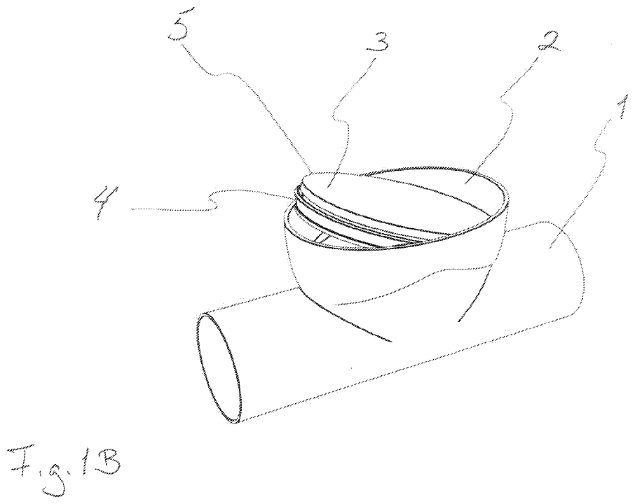

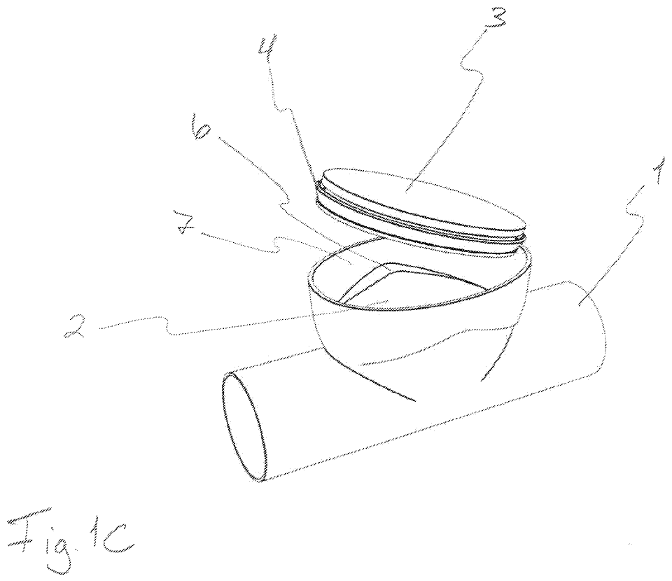

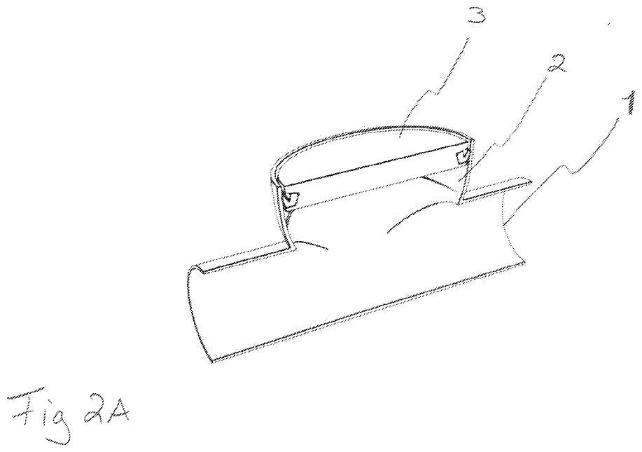

FIGS. 1A-1C illustrates in sequence opening and removal of a lid 3 covering an opening 2 in a housing element of a vacuum pipe 1. A housing element of a vacuum pipe 1 with an opening 2 covered by a lid 3 is illustrated in FIG. 1A. The housing element may be provided with an inlet and an outlet for connecting to the vacuum pipes in the vacuum system providing the vacuum system with an opening with a lid. The housing element may be connected to the closed system providing an opening with a lid in the closed system. A number of such housing elements may be connected and integrated with the closed system in positions where it is desirable to be able to open a lid for gaining access to the inside of the closed system. The lid 3 is in a closed and fluid-tight position covering the opening 2 of the vacuum pipe 1. A periphery of the lid has a corresponding shape and size with an inside of the opening. The opening 2 of the vacuum pipe enables inspection, maintenance and removal of items and dirt from inside the vacuum pipe. The lid provides a fluid tight seal for the vacuum system and thus provides a seal for liquid, gas and solids. The vacuum system maintains a closed system when the lid is in place in the opening. In the embodiment in FIG. 1A, the opening in the housing extends up from the vacuum pipe to avoid liquid and dirt coming out from the vacuum pipe when the lid is removed and the opening into the vacuum pipe exposed. The opening increases in its perimeter in the direction away from the opening. This increase in the perimeter of the opening in the direction away from the opening into the vacuum pipe enables easy access to the inside of the vacuum pipe when the lid is removed.

FIG. 1B illustrates the vacuum pipe with the lid from FIG. 1A with the lid 3 in a partly open position after a part of the lid has been depressed and the vacuum pressure overcome for opening of the lid as explained above. The lid is provided with a sealing element 4 around the circumference 5 of the lid. The sealing element may be an integrated part of the lid. The sealing element may be a separate element from the lid. The sealing element may be resilient and compressible to enable sealing of the lid against the inside of the opening when in a closed position. The sealing element 4 may have a slightly inclined shape with the largest diameter towards the outside of the lid. The sealing element 4 together with the circumferential design of the lid enables a sliding movement of the lid along the inside of the opening 2 as well as a fluid tight seal against the opening 2. As may be seen from FIG. 1B, the lid 3 is designed to pivot around a pivot axis of the lid 3. A part of the lid is designed to be able to move out of the opening 2, whereas the opposite side of the lid is designed to move into the opening. The rotating movement of the lid around the pivot axis is part of the solution enabling easy opening of the lid 3. FIG. 1C illustrates the vacuum pipe 1 with the lid 3 removed from the opening 2. The sealing element 4 around the circumference may be clearly seen. Inside the opening 2 a first area 6 may be seen against the inside wall 7 of the opening 2. The first area 6 provides a first pivot area for the lid 3. A corresponding second area 8 (not visible in FIG. 1C) is provided diametrically opposite of the first area 6 against the wall inside the opening. The line between the first area 6 and the second area 8 provides the pivot axis 9 for the lid. The first 6 and second 8 pivot areas are rounded at the top as may be seen in FIG. 1C. The rounded top of the first 6 and second areas 8 increases the pivot area and reduces the forces on the pivot area. The example embodiment is for use in a vacuum sewage system and the material of the pipes and tanks are often made of polypropylene or other similar lightweight materials. Such materials are not designed to withstand high pressures, and a larger area for distribution of forces in the pivot areas may be required. A rounded top area is also provided for improved force distribution. The rounded top also enables a smooth pivot movement of the lid 3 around the pivot axis 9. In other embodiments where the lid is made of materials withstanding higher pressures, the top part of the pivot area may be an edge. The edge may be sharp. An edge shape increases the forces on the lid by the edge. In the embodiment illustrated in FIG. 1A-C, the lid is stiff and designed to withstand the forces on the lid due to the vacuum and top areas defining the pivot areas for rotation. As explained above, the materials used for the lid is adapted to the shape of the pivot areas and vice versa. The lid illustrated in FIGS. 1A-C has an oval shape. The lid may have other shapes; e.g. a circular shape or an even more elliptic shape. The lid may also be provided with hinges dividing the area of the lid in two halves enabling operating a half of the lid at a time. The lid may be hinged to the opening e.g. through the longitudinal element 31. The lid may be transparent to enable looking into the pipe system or tank. Due to the forces acting on the lid, the area of the lid should also not be too large. The material of the lid may be adapted to the specific use and system requirements. A lid of rubber and with integrated steel elements, may also be possible.

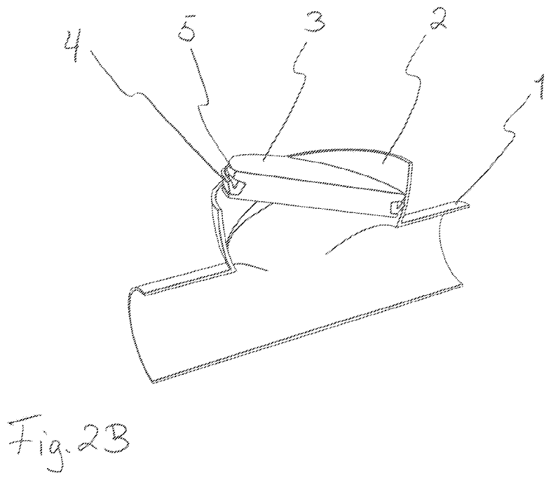

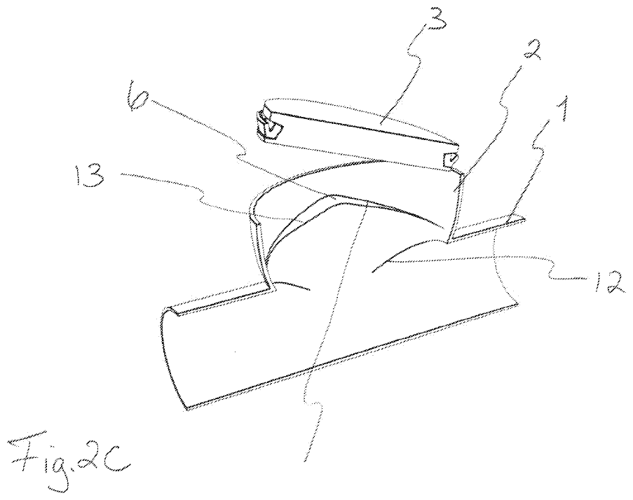

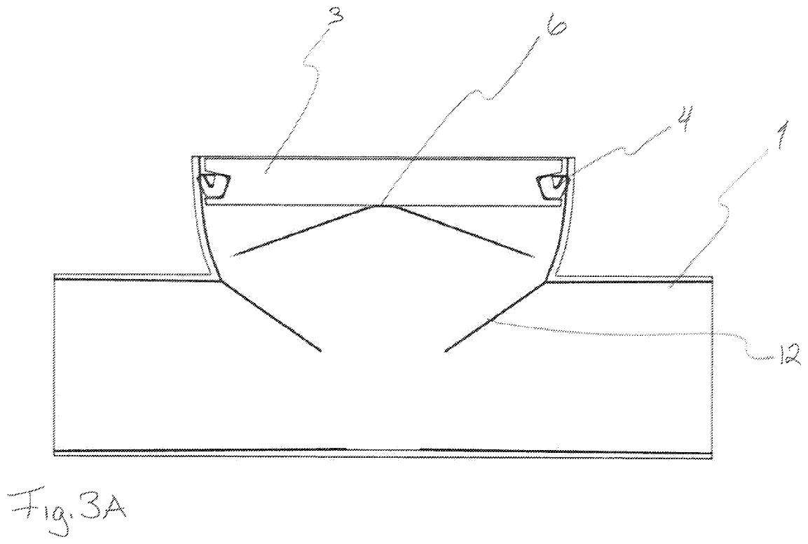

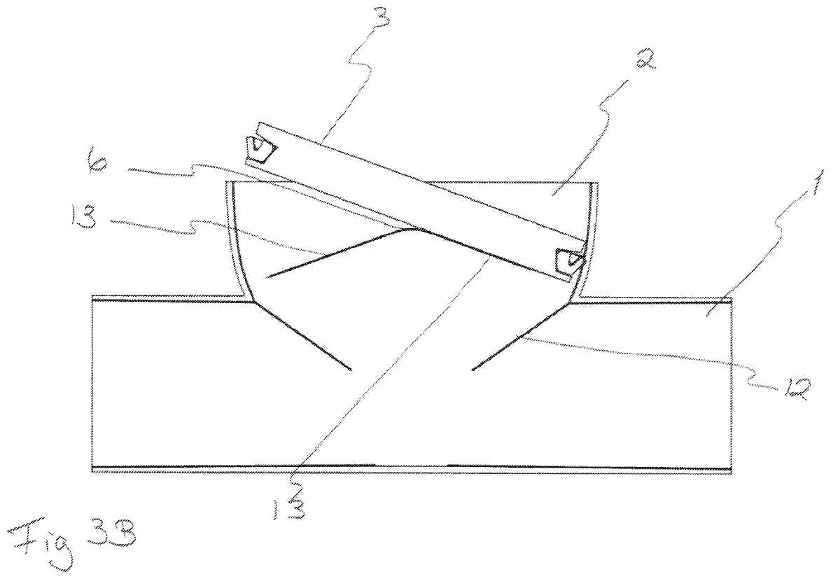

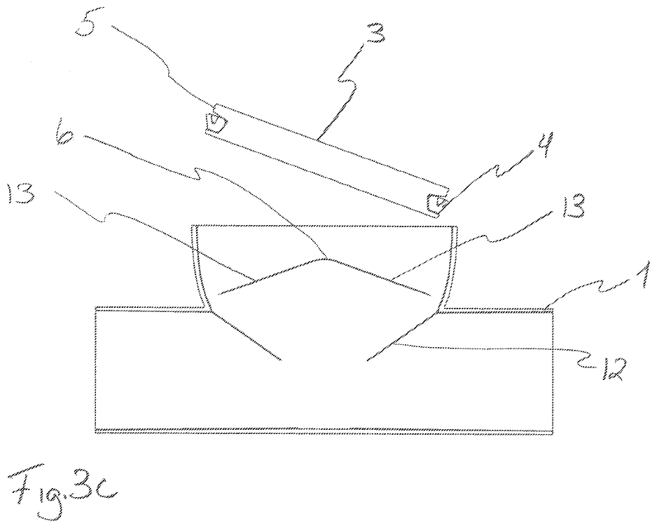

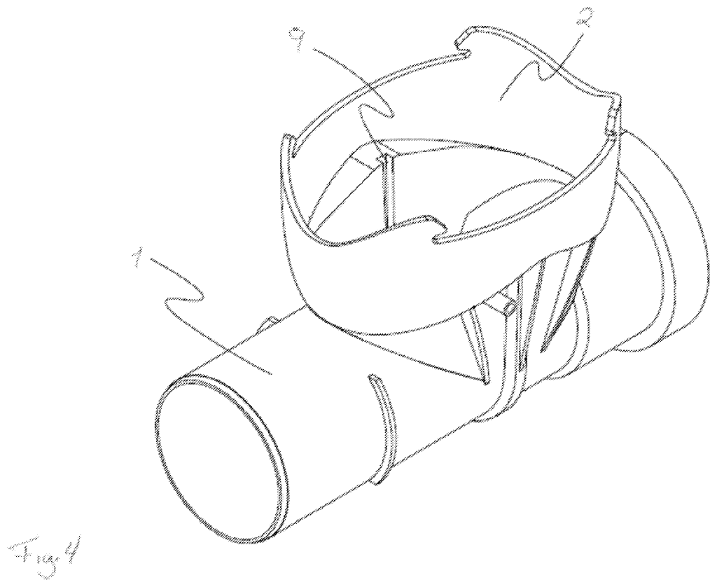

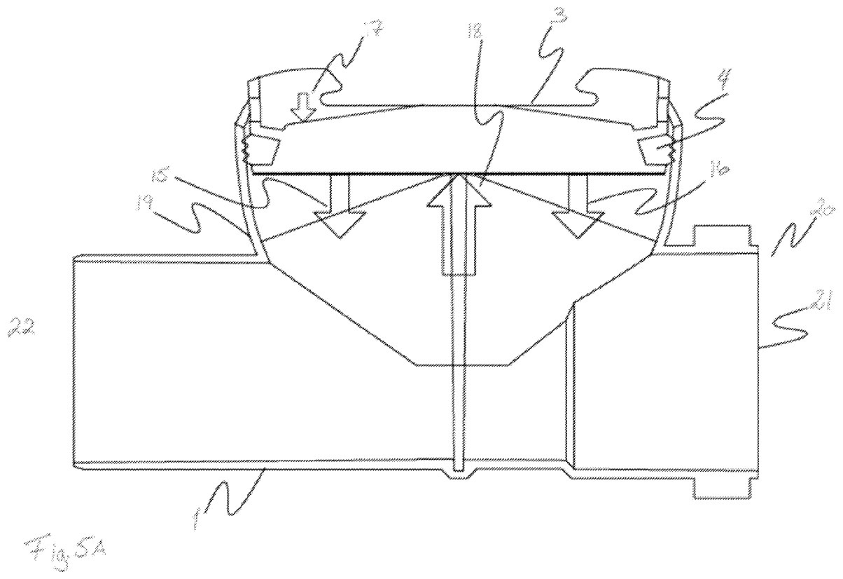

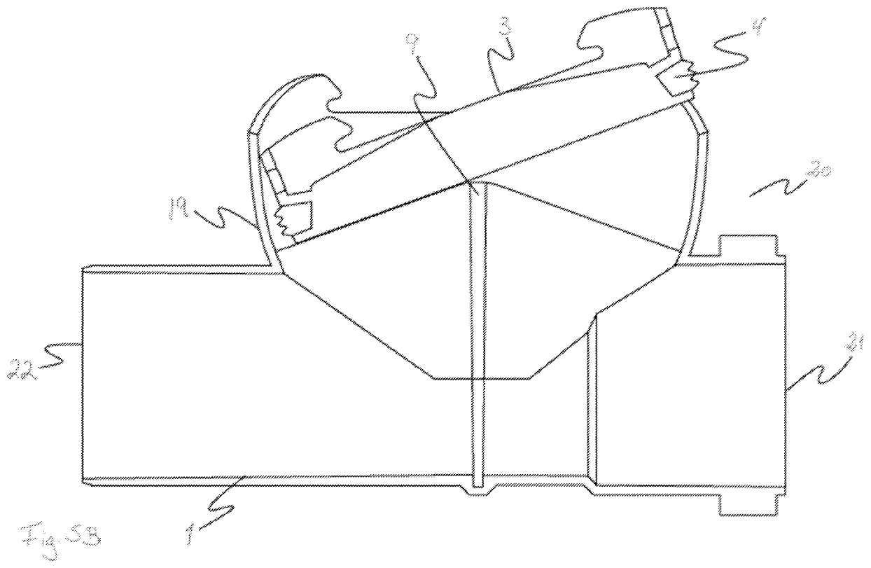

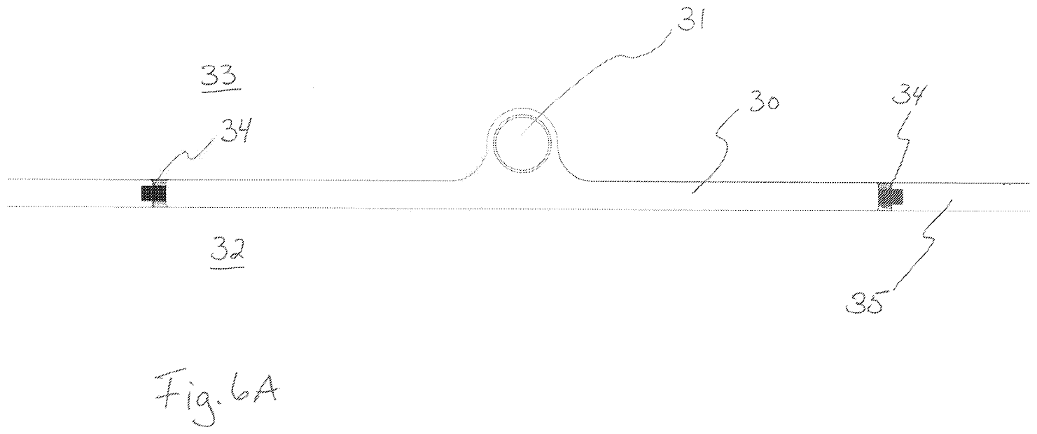

FIGS. 2A-2C illustrates in longitudinal cross-sectional view the vacuum pipe housing 1 with opening 2 and lid 3 and the sequence of opening the lid from FIGS. 1A-1C. FIG. 2A illustrates in a longitudinal cross-sectional view the lid in a closed and fluid-tight position covering the opening in the vacuum pipe from FIG. 1A. The sealing element 4 is seen to bear closely against the inside wall 10 of the opening 2. FIG. 2B illustrates in a longitudinal cross-sectional view the vacuum pipe housing with opening 2 and lid 3 partly opened from FIG. 1B. The pivoting movement of the lid 3 about the pivot axis 9 (FIG. 4) is seen with the first end of the lid on a first side of the pivot axis 9 in a position up above the inside wall of the opening and the other end of the lid 3 on the other side of the pivot axis 9 in a downward position inside the wall of the opening 2. FIG. 2C illustrates in a longitudinal cross-sectional view the vacuum pipe housing with the lid 3 removed 30) from the opening 2 from FIG. 1C. The sealing element 4 is seen in more detail in the cross-sectional view. The sealing element 4 is arranged in a recess 11 around the periphery of the lid. The sealing element has a V-shape that allows the sealing element to flex when bearing against the inside wall of the opening providing a fluid tight seal and at the same time may allow the sliding movement of the lid 3 with sealing element 4 against the inside wall of the opening 2 as illustrated in FIG. 2B. The first pivot area 6 is also illustrated in FIG. 2c with the rounded top area and a downwardly inclined area 13 on each side of the rounded top. The downwardly inclined area 13 increases the strength of the opening structure enabling to withstand the forces applied to the structure by lid. The material in the embodiment in FIGS. 1-3 may be made of e.g. polypropylene or similar material. The downwardly inclined area may also provide a support for the part of the lid pivoting into the opening when performing the pivot movement for opening the lid. In other embodiments, the downwardly inclined area 13 might be omitted depending on the material used for the housing element and pipe system. The second pivot area 8 arranged opposite of the first pivot area 6 inside the wall of the opening have a corresponding shape as the first pivot area 6. The downwardly inclined area 13 of the pivot area need not extend down to meet the corresponding pivot area. i.e. extend around the entire inner circumference of the opening, but may also partly extend along the inside of the wall of the opening. The pivot area with the downwardly inclined area is illustrated in more detail in FIGS. 3A-3C. FIGS. 3A-3C illustrate in a longitudinal partly cross-sectional view the sequence of the opening of the lid from FIGS. 1A-1C but also illustrate the interaction between the underside of the lid and the pivot area of the inside of the opening. In FIG. 3A, the lid is in a closed position with the underside of the lid bearing against the rounded top part of the pivot area 6. In FIG. 3B, the lid is in the open position with the second end of the lid being in the downward position bearing against the downwardly inclined area 13 of the pivot area 6. In FIG. 3C, the lid is removed. When the lid is removed from the opening, the lid is in a free position where the lid is loose and not attached to the opening. FIGS. 3A-3C also illustrate the inside of the opening 2. The lower part 12 of the opening 2 has a funnel like shape facing the inside of the vacuum pipe. This funnel like shape may provide a protection against liquid and dirt coming out of the vacuum pipe when opening and removing the lid. FIG. 4 is a view of the opening and inside of the housing element from partly above showing the pivot area 6 on one of the sides. The pivot axis 9 is illustrated as a line moulded into the inside of the housing.

FIG. 5A also illustrates forces acting on the lid 3 when the lid is in a closed position in the opening 2 of the vacuum system 1. The forces acting on the lid are illustrated with the arrows. The size of the arrows are illustrations only and may not be the actual size of the force. A larger arrow illustrates a larger force than a smaller arrow.

The force F holding the lid 3 in place in the opening 2 of the vacuum system is the area A of the underside of the lid multiplied by the difference in pressures P between the inside of the vacuum system and the outside ambient air:

$$F = A * P .$$

The pressure P of the ambient air is approximately 1 bar and the pressure inside the vacuum system illustrated in FIG. 1 in use is about 0.45 bar. The size of the lid for covering the opening 2 in the vacuum system may vary depending on the use the system is intended for. As an example, the area of the lid may be 50 cm². This provides a force acting on the lid of approximately 275 N. It thus requires a large force to overcome the forces due to the vacuum in vacuum system due to the pressure difference between the inside and the outside of the vacuum system. This is a force that might be difficult to overcome by pulling out the lid from the opening in the vacuum system. The lid in a typical vacuum system e.g. for sewage, may therefore not be removed by e.g. a hand of a human being when the pressure in the closed system has not been equalized with the surroundings. In FIG. 5A, the lid is placed on a pivot point, or rather a pivot axis 9. The pivot axis is arranged in a middle part of the lid. The lid is divided in two areas by the pivot axis. The two areas are equal or about equal. The area of the underside of the lid is divided in two areas as indicated by the first force 15 and the second force 16 acting on the lid. These two areas with the first force and the second force represent two forces, each trying to push the lid towards and into the opening (chamber), but at the same time working against each other, as the stiffness of the lid balances these two forces around the pivot axis. The force 18 (largest arrow) in the middle of the lid is the force acting on the underside of the lid due to the pivot axis provided by the pivot areas of the opening. By applying a small force towards the outside surface of the lid on one of the sides of the lid, in this case the left side (arrow 17 in FIG. 5A), a small force is added to the first force 15, and the resulting force acting on the outside of the lid towards the inside of the vacuum system is then large enough to overcome the friction of the system and rotate the lid anti-clockwise around the pivot axis as seen from the side in the cross-sectional view of FIG. 5B. The force applied to the lid is near the periphery of the lid. This resultant force on the lid from the outside and towards the inside of the vacuum system is then large enough to move the right part of the lid above the opening in the vacuum system as illustrated in FIG. 5B. The left side of the lid moves down into the opening as illustrated in FIG. 5B. The sealing element 4 slides against the inside of the opening. As the right tip of the lid moves above the opening, the pressure on the underside and overside of the lid equilibrates, leaving the lid easy to remove from the opening. The small force required to open the lid is considerably smaller than the forces from the vacuum system acting on the lid.

The design of the lid may depend on the closed system and the system requirements and for the intended use of the lid and also the positioning of the lid in the closed system. The closed system may e.g. be a large vacuum system for sewage transport. The design of the lid may also depend on whether the lid should be manually operated or operated by a machine as explained above.

Having described example embodiments of the invention it will be apparent to those skilled in the art that other embodiments incorporating the concepts may be used. These and other examples illustrated above are intended by way of example only and the actual scope of the invention is to be determined from the following claims.

1. A lid adapted for fluid tight sealing engagement with an opening in a closed system where a pressure on an outside of the closed system is higher than a pressure on an inside of the closed system, wherein the lid is arranged to perform a pivoting movement around a pivot axis for opening the lid.

2. The lid according to claim 1, wherein the lid is fluid tight held in place in the opening by balancing the forces on the lid due to a pressure difference between the inside and the outside of the closed system.

3. The lid according to claim 1, wherein the pivot axis is arranged in a middle part of the lid.

4. The lid according to claim 1, wherein the pivot axis divides an area of the lid in a first area and a second area, and wherein the first area is equal to or about equal to the area of the second area.

5. The lid according to claim 1, wherein the pivot axis is provided by a longitudinal element, a geometry in the lid or a geometry in the opening.

6. The lid according to claim 1, wherein the closed system is a vacuum system.

7. The lid according to claim 1, wherein the opening in the system is an opening in a pipe or a tank.

8. The lid according to claim 1, wherein the pivoting movement for opening the lid is initiated by a force applied on a part of the lid in an area near or on a periphery of the lid away from the pivot axis.

9. The lid according to claim 1, wherein the lid is provided with a fluid tight sealing element around a periphery of the lid for sealing engagement between the opening in the closed system and the lid.

10. The lid according to claim 1, wherein a periphery of the lid is arranged to be able to slide on a surface of the opening for at least a part of the pivoting movement.

11. A lid system for fluid tight sealing of an opening in a closed system where a pressure on an outside of the closed system is larger than a pressure on an inside of the closed system, the lid system comprising:
a housing element including the opening, wherein the housing element further includes at least one connecting element for connecting the housing element to the closed system; and
a lid arranged to perform a pivoting movement around a pivot axis for opening the lid.

12. The lid system according to claim 11, wherein the lid is fluid tight held in place in the opening by balancing the forces on the lid due to a pressure difference between the inside and the outside of the closed system.

13. The lid system according to claim 11, wherein the pivot axis is arranged in a middle part of the lid.

14. The lid system according to claim 11, wherein the pivot axis divides an area of the lid in a first area and a second area, and wherein the first area is equal to or about equal to the area of the second area.

15. The lid system according to claim 11, wherein the pivot axis is provided by a longitudinal element, a geometry in the lid or a geometry in the opening.

16. The lid system according to claim 11, wherein the opening in the housing is provided with two opposing pivot areas defining the pivot axis.

17. The lid system according to claim 11, wherein the lid is provided with a fluid tight sealing element around a periphery of the lid for sealing engagement between the opening and the lid.

18. The lid system according to claim 11, wherein the opening is provided with a fluid tight sealing element for sealing engagement between the opening and the lid.

19. The lid system according to claim 11, wherein an outer periphery of the lid is arranged to be able to slide on a surface of the opening for at least a part of the pivoting movement.

20. The lid system according to claim 11, wherein the pivoting movement for opening the lid is initiated by applying a force on a part of the lid in an area near or on a periphery of the lid away from the pivot axis.

21. The lid system according to claim 11, wherein the opening in the housing extends up from the closed system.

22. The lid system according to claim 11, wherein a perimeter of the opening increases in a direction away from the closed system.

23. The lid system according to claim 11, wherein the closed system is a vacuum system.

24. A housing element for a lid system for fluid tight sealing of an opening in a closed system where a pressure on an outside of the closed system is larger than a pressure on an inside of the closed system and the lid is arranged to perform a pivoting movement around a pivot axis for opening the lid, the housing element comprising the opening, wherein the housing element further comprising at least one connecting element for connecting the housing element to the closed system.

25. The housing element according to claim 24, wherein the opening in the housing element extends up from the closed system.

26. The housing element according to claim 24, wherein a perimeter of the opening increases in a direction away from the closed system.

27. (canceled)

28. (canceled)

29. (canceled)

30. Use of the lid according to claim 1 as an inspection opening in a vacuum sewage system for at least one of toilets, sinks, greywater, black water, water or organic material, or as an inspection opening in a vacuum system for condensed water, in a vacuum system for transporting condensed water from at least one cooler or refrigerator, in a vacuum system for transport of condensed water from at least one of a cold counter, display fridge or refrigerator counter in a shop or supermarket.

31. (canceled)

32. Use of the housing element according to claim 24 providing an inspection opening in a vacuum sewage system for at least one of toilets, sinks, greywater, black water, water or organic material, or providing an inspection opening in a vacuum system for condensed water, in a vacuum system for transporting condensed water from at least one cooler or refrigerator, in a vacuum system for transport of condensed water from at least one of a cold counter, display fridge or refrigerator counter in a shop or supermarket.

33. (canceled)
